(19) United States
(12) Patent Application Publication
(10) Pub. No.: US 2009/0218982 A1
(43) Pub. Date: Sep. 3, 2009

(54) RECHARGABLE POWER SUPPLIES FOR PORTABLE MEDICAL EQUIPMENT

(75) Inventor: Jennifer Lynn Martin, North Prairie, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/040,463

(22) Filed: Feb. 29, 2008

(51) Int. Cl. H01M 10/44; H02N 6/00

(52) U.S. Cl. 320/101; 136/245

(57) ABSTRACT

Systems and methods for providing power to portable medical equipment using natural energy, such as solar energy. In one embodiment, a solar charging system is portable and has at least one flexible solar panel. Preferably, the solar panel is foldable and configured to convert solar energy into electrical energy, as required to charge rechargeable batteries and/or the like and operate the portable medical equipment. Preferably, the solar charging system is connected to the portable medical devices through an interface, and the interface is configured to make an output of the solar panel compatible for powering the portable medical equipment.

### FIELD OF INVENTION

In general, the inventive arrangements relate to portable medical equipment. More specifically, they relate to systems and methods for recharging portable medical devices using natural energy.

### BACKGROUND OF INVENTION

Healthcare facilities in rural areas need to be developed for improving the health status of people in rural areas. Improvements in health status can be achieved by making medical equipment available in rural areas. Portable medical devices play an important role in improving healthcare facilities, and particularly so in many rural areas. However, portable medical devices are often only backed up by a small internal battery to enable remote use of the medical equipment. The users of these portable devices must provide adequate power to their devices, and currently, they are often forced to use rechargeable batteries. To recharge their rechargeable batteries, however, the operators typically need access to a reliable and convenient source of electricity.

However, there can be certain areas and/or situations where there is not a convenient and/or sufficient electrical power supply readily available to recharge the batteries for many portable medical devices. Where there is no electricity, or a shortage thereof, the operator often needs to carry multiple sets of batteries. Oftentimes, however, this is not feasible, as power shortages are often, by their nature, unpredictable. Moreover, batteries utilized by portable devices are often expensive, thus requiring a substantial investment to carry multiple batteries. Additionally, batteries appropriate for use by portable medical devices can often be harmful to the environment, and even hazardous when disposed of. Furthermore, batteries of the type used in portable medical devices are often bulky and heavy, causing both discomfort and inconvenience during transport.

Also due, at least in part, to environmental concerns, it would be particularly beneficial to charge a power source for portable medical devices using natural resources, such as solar power, wind power, and/or the like.

Several existing solutions for charging lower power devices, such as laptop computers, mobile phones, etc., use solar panels to recharge their batteries. However, the power requirements for many portable medical devices are often relatively and/or moderately high, and there are no mechanisms to charge their types of batteries without direct access to electrical power. For example, portable medical equipment might typically require electrical power in a range of 100-240 volts. Thus, it would often be advantageous to be able to naturally recharge the batteries for portable medical devices when there is not otherwise direct access to electricity.

Therefore, a need exists for an efficient, compact, natural, and/or reliable battery charging mechanism for providing uninterrupted power supplies of sufficient power to adequately power portable medical equipment.

### SUMMARY OF INVENTION

The above-mentioned shortcomings, disadvantages and problems are addressed herein, which will be understood by reading and understanding the following specification.

One embodiment of the inventive arrangements provides a portable power supply unit for portable medical devices. The power supply unit includes a portable solar charging system having at least one flexible solar panel and an interface coupled to the solar charging system. The interface is configured to make the output of the solar charging system compatible for powering the portable medical device.

In another embodiment, a portable medical system is disclosed, comprising a medical imaging device having an imager and a power storage device, as well as a detachable solar charging system, capable of recharging the power storage device. In this same or a different embodiment, the system can further comprise an interface connecting the imager with the solar charging system and configured to stabilize the output of the solar charging system to make it usable for recharging the power storage device.

In yet the same or another embodiment, a method of providing uninterrupted power to a portable medical device is disclosed, providing a power storage device integrated with a portable medical device and recharging the power storage device using a detachable solar charging system. Preferably, the solar charging system is provided with a flexible solar panel.

Various other features, objects, and advantages of the inventive arrangements will be made apparent to those skilled in the art from the accompanying drawings and detailed description thereof.

### BRIEF DESCRIPTION OF DRAWINGS

FIG. 1 is a representative block diagram of a power supply unit that can be used with portable medical devices according to the inventive arrangements;

FIG. 2 is a representative block diagram of a portable medical system for use with a medical imaging device according to the inventive arrangements;

FIG. 3 is a diagrammatic representation of charging portable medical equipment using a power supply unit according to the inventive arrangements; and

FIG. 4 is a flowchart illustrating a method of providing uninterrupted power to portable medical equipment according to the inventive arrangements.

### DETAILED DESCRIPTION OF INVENTION

In the following detailed description, reference is made to the accompanying drawings that form a part hereof, and in which is shown, by way of illustration, specific embodiments that may be practiced. These embodiments are described in sufficient detail to enable those skilled in the art to practice the embodiments, and it is to be understood that other embodiments may be utilized and that logical, mechanical, electrical, and/or other changes may be made without departing from the scope of the embodiments. The following detailed description is, therefore, not to be taken as limiting the scope of the inventive arrangements.

In various embodiments, a power supply unit for portable medical equipment is disclosed. Representative portable medical equipment include devices such as portable ultrasound imaging systems, portable patient monitoring systems, portable drug delivery systems, portable life monitoring systems, portable non-ultrasound imaging systems, and hand-held medical diagnostic image devices, etc. Their power supply units may recharge batteries in different portable medical diagnostic and/or portable medical therapeutic devices.

In one embodiment, the inventive arrangements provide an environmentally friendly portable battery charger that uses natural energy resources to recharge batteries.

In various embodiments, a portable medical system is also disclosed. Preferably, the portable medical system includes a medical imager and a detachable and/or flexible solar panel so that a charging mechanism is also able to be portable along with the portable medical system. Preferably, the portable medical system is a medical imaging system.

In various embodiments, the inventive arrangements also disclose a method of providing uninterrupted power to portable medical devices. The portable medical devices can also be provided with a regular power source in association with rechargeable batteries for carrying out normal, non-battery operations. Whenever there is a shortage of electrical power to recharge the batteries associated with the power source, a portable solar panel, for example, along with a suitable interface, can be used to thus recharge the batteries.

In one embodiment, environmentally conscious alternatives for charging batteries associated with portable medical equipment are disclosed.

In one embodiment, the inventive arrangements also provide a method for recharging the batteries of portable imaging systems using natural energy resources.

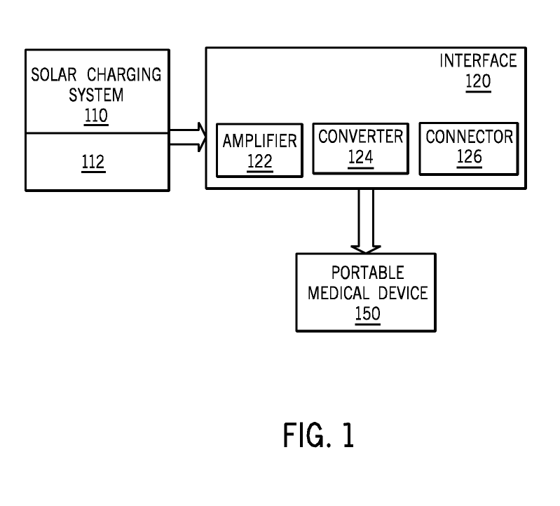

Now then, FIG. 1 is a block diagram of a portable power supply unit that can be used with portable medical devices, as described in various embodiments of the inventive arrangements. The portable medical devices can include devices such as portable ultrasound imaging systems, portable patient monitoring systems, portable drug delivery systems, portable life monitoring systems, portable non-ultrasound imaging systems, and hand-held medical diagnostic image devices, etc. However these examples of portable medical devices need not be limited to these.

In the figure, the portable power supply unit includes a solar charging system 110 coupled with a portable medical device 150 through an interface 120. The solar charging system 110 is used for recharging batteries for the portable medical device 150. Preferably, the solar charging system 110 includes an energy conversion device 112, such as a solar panel and/or photovoltaic module, configured to convert, for example, the solar energy and/or the like into electrical energy. Preferably, such energy conversion devices 112 may be operable to produce one or more levels of power. For example, one solar panel module may be used to produce several watts of power at several different voltage and current levels, such as 2.2 watts at 7.6 volts and 290 milliamps, 2-12 volt levels, 300 watts, etc. Additionally, each solar panel may include at least two conductive elements, such as positive and negative reference terminals, for directing current and/or power provided by using solar energy to an output port.

In one embodiment, the energy conversion device 112 is operable to receive solar energy and convert solar energy into a direct current or voltage. For example, the energy conversion device 112 may include a rigid solar panel and/or a flexible solar panel. Flexible solar panels, for example, advantageously allow for increased durability and easy of use, particularly with portable systems. Several different types of solar energy panels may be used to output the energy as needed, and they may be operable to output several different levels of energy sufficient to charge various portable medical devices 150.

In one embodiment, the solar charging system 110 is preferably configured to be portable. For example, a flexible solar panel would be highly portable for charging the portable medical device 150. In one embodiment, at least one foldable and detachable solar panel can be used, so that the user can separate and/or detach the solar charging system 110 from the portable medical device 150 and, for example, fold the solar panel and carry it separately. Multiple foldable solar panels can also be connected together to provide sufficient power to recharge the portable medical devices 150.

Preferably, the solar charging system 110 is connected to the portable medical device 150 using an interface 120, which is configured to regulate the output of the solar charging system 110 and make it usable for powering the portable medical device 150. In one embodiment, the interface 120 preferably includes one or more of an amplifier 122, converter 124, and/or connector 126. The output of the solar charging system 110 can be a low-power output, and hence, may need to be voltage, current, and/or power amplified to make it usable for recharging the batteries in the portable medical devices 150. For example, the amplifier 122 may amplify the output of the solar charging system 110, as per the requirements of the portable medical device 150. It can also be done as single or multiple stages of amplification. Once the output, current, voltage, and/or power output of the solar charging system 110 has been amplified, the amplified signal can then be converted into a different format, if desired, again as per the requirements of the portable medical device 150. For example, if the output of the solar charging system 110 is direct current (DC) and the portable medical device 150 operates on alternating current (AC), then the converter 124 may need to convert the DC output of the solar charging system 110 into an AC signal for the portable medical device 150. In different embodiments, the amplification and/or conversion stages may also be interchanged, as needed and/or desired. The connector 126 can also be configured to establish a connection between the solar charging system 110 and the portable medical device 150 and ensure appropriate voltage, power, and/or current is supplied to the portable medical device 150. For example, the connector 126 could include a USB connector, a DC connector, an AC connector, and/or the like. The connector 126 may also vary depending on the various configurations of the solar charging system 110 and the portable medical device 150, as needed and/or desired.

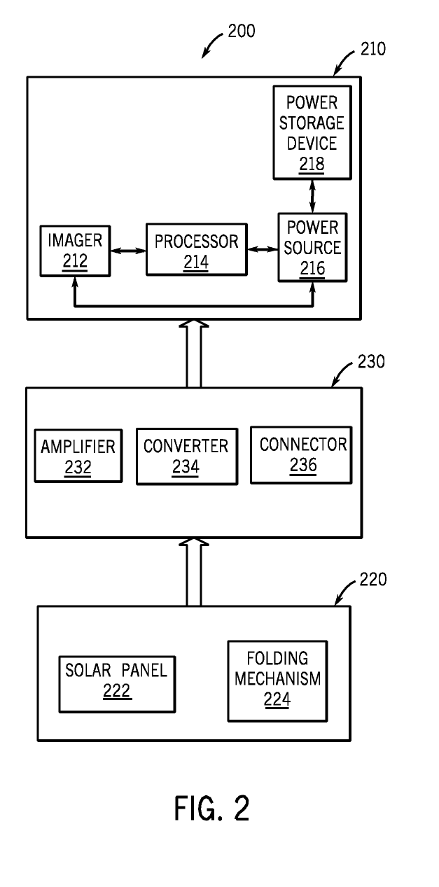

FIG. 2 is a block diagram of a portable medical system 200, as described in one embodiment of the inventive arrangements. One example of such a portable medical system 200 is an imaging system, such as a portable ultrasound imaging system. However, it could also be other portable medical systems 200 as well. Preferably, the portable medical system 200 includes a medical imaging device 210, a solar charging system 220, and an interface 230 therebetween. Preferably, the medical imaging device 210 comprises an imager 212 for imaging a patient. The images acquired by the imager 212 are fed to a processor 214 for processing the images and can then be displayed if desired. A power source 216 is also provided to supply power to all of the electrical components, such as the imager 212, processor 214, and/or other interface circuitry in the medical imaging device 210. Preferably, the power source 216 also comprises a standard cord and plug for insertion into a typical electrical outlet. For example, a standard outlet providing 120 or 210 volts is typical. A three-phased power source 216 may also be used. Preferably, the power source 216 is further coupled to a power storage device 218 for charging the same. In one example, the power storage device 218 comprises rechargeable batteries. Preferably, the power source 216 provides electrical power to components in the medical imaging device 210 and also charges the rechargeable batteries and/or power storage device 218.

In one embodiment, the solar charging system 220 is also provided as an alternative for charging the power storage device 218 within the medical imaging device 210. Preferably, the solar charging system 220 includes at least one solar panel 222. The solar panel 222 may also include an array of cells and be arranged in the form a panel. Different types of solar panels 222 may include photovoltaic cells, mono crystalline cells, poly crystalline cells, amorphous cells, and/or the like. Preferably, the solar panel 222 is provided with a folding mechanism 224 to make it flexible and/or portable. In one embodiment, multiple solar panels 222 can also be connected together using the folding mechanism 224.

In one embodiment, the medical imaging device 210 is connected with the solar charging system 220 through the interface 230. The interface 230 may include an amplifier 232, converter 234, and/or connector 236. Preferably, the amplifier 232 is configured to voltage, current, and/or power amplify the solar charging system 220 output, as needed and/or required. For example, the solar panel 222 may not provide an output that is sufficient to charge the medical imaging device 210, and hence, it may need to be amplified. In various embodiments, the converter 234 may also include electronic components configured to convert the energy output from the solar charging system 220 to a specific level based on a charge specification of the medical imaging device 210. Additionally, other devices, such as current limiting devices, e.g., fuses and blocking diodes, may also be provided to safely charge the medical imaging device 210 without risking damage to and/or depleting energy within the portable medical system 200. Preferably, the connector 236 is configured to provide an appropriate power and/or current supply to the medical imaging device 210. As such, the connector 236 could include a USB connector, DC connector, AC connector, Ethernet port, and/or the like. Various connectors 236 may vary depending on the solar charging system 220 and the medical imaging device 210.

In one embodiment, the components and configuration of the interface 230 may also vary depending on the configuration of the portable medical system 200.

In one embodiment, the interface 230, and/or various components thereof, such as the amplifier 232, converter 234, and/or connector 236, may also be provided as a part of the solar charging system 220. For example, the amplifier 232 and/or converter 234 may be provided as a part of the solar charging system 220 and the connector 236 could also be associated with the solar charging system 220. Alternatively, the interface 230 may be a cable connecting the solar charging system 220 directly to the medical imaging device 210.

In another embodiment, the interface 230, or parts of the interface 230, may also be provided as a part of the medical imaging device 210.

Once the rechargeable battery or batteries need to be charged or re-charged, the solar charging system 220 can be attached to the medical imaging device 210 using the interface 230. Then, the solar panel 222 will convert the solar energy and/or the like into electrical energy. The electrical energy thus generated is fed to the medical imaging device 210 through the interface 230. The interface 230 regulates the electrical power generated by the solar charging system 220 to make it usable to charge the power storage device 218 within the medical imaging device 210. Thus, the medical imaging device 210 can be operated in an environment where there is unpredictable or little or no electricity.

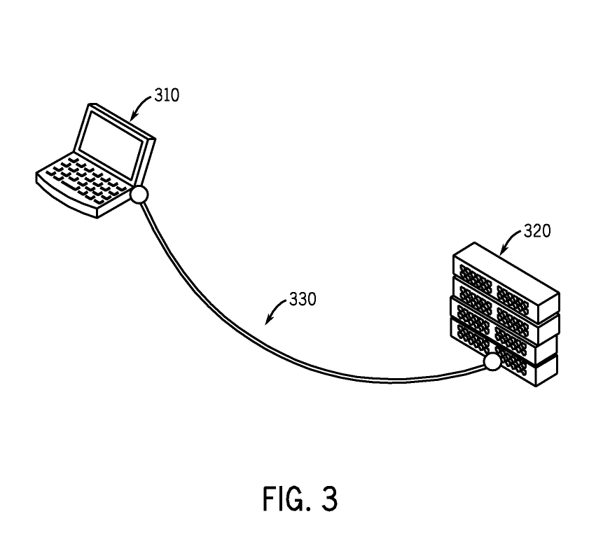

FIG. 3 is a diagrammatic representation of charging portable medical equipment using a portable power supply unit as described by the inventive arrangements. The portable medical device 310 includes portable devices, such as portable ultrasound imaging systems, portable patient monitoring systems, portable drug delivery systems, portable life monitoring systems, portable non-ultrasound imaging systems, and hand-held medical diagnostic image devices, etc. Generally the portable medical devices 310 can be provided with a power source (not shown) for powering the same. The power source may comprise a standard cord and plug for insertion into a typical electrical outlet. For example, a standard outlet providing 120 or 210 volts is typical. A three-phased power source, or any other specialized outlets and plugs, may also be provided. Preferably, the portable medical device 310 is further provided with a power storage device, such as rechargeable batteries. Preferably, a solar charging system 320 is provided to charge the rechargeable batteries of the portable medical device 310, particularly when the regular power supply provided by the power source is not available to power the portable medical device 310. Preferably, the solar charging system 320 includes at least one foldable solar panel that can be attached to the portable medical device 310 as and when the portable medical device 310 needs to be charged. Preferably, the solar panels may be used to produce several watts of power at several different voltage and current levels. The solar panel may also include photovoltaic cells, mono crystalline cells, poly crystalline cells, amorphous cells, and/or the like. Preferably, the potable medical device 310 is connected to the solar charging system 320 using an interface 330. Preferably, the interface 330 is configured to make the output of the solar charging system 320 compatible with the power requirements of the portable medical device 310. The interface 330 may also include a voltage regulator, amplifier, converter, connector, and/or any other devices (not shown), which could be used to make the voltage, current, or power output of the solar charging system 320 usable to charge the batteries in the portable medical device 310. However, the configuration of the interface 330 may change depending upon the power requirements of the portable medical device 310.

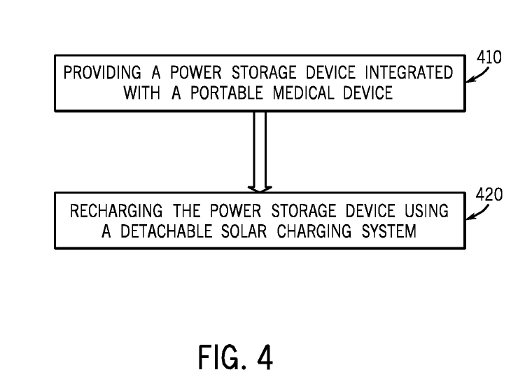

FIG. 4 is a flowchart illustrating a method of providing uninterrupted power to portable medical devices. At step 410, a portable medical device is provided with a power storage device integrated within the system. The power storage device is used to store power, so that the devices can work even if they are not connected to an external power source. In an example, portable medical devices are provided with rechargeable batteries as a power storage device, so that the devices can work even if they are not directly connected to another power supply for a limited time. Generally, electrical power is used to recharge the batteries. At step 420, a solar charging system is instead attached to the portable medical device for charging the power storage device within the portable medical device. Preferably, the solar charging system includes e.g. a foldable solar panel and is connected to the portable medical device though an interface, as previously described. Preferably, the interface is configured to regularize the power generated by the solar charging system, so that it is or becomes useable to charge the batteries in the portable medical equipment.

Some of the advantages of the inventive arrangements include the ability to efficiently utilize the capacity of portable medical devices. The arrangements facilitate extending the usage of medical facilities to rural areas where there is little or no electricity to otherwise power the portable medical devices. They also present an environmentally friendly method for providing power to portable devices. They also present a portable power supply mechanism that can be used with many portable imaging systems. The arrangements also provide compact, efficient, and nature friendly techniques for charging rechargeable batteries in portable medical equipment environments.

Thus, various embodiments disclosed herein describe various techniques for providing uninterrupted power to portable medical devices using natural sources of energy.

While the inventive arrangements have been described with reference to preferred embodiments, those skilled in the art will appreciate that certain substitutions, alterations, and/or omissions may be made to the embodiments without departing from the spirit of the invention. Accordingly, the foregoing description is meant to be exemplary only and should not limit the scope of the invention as set forth in the following claims.

What is claimed is:

1. A power supply for a portable medical device, comprising:
a portable solar charging system having at least one flexible solar panel; and
an interface coupled to the solar panel,
wherein the interface is configured to make an output signal of the solar panel compatible for powering the portable medical device.

2. The power supply of claim 1, wherein the solar panel is foldable.

3. The power supply of claim 1, wherein the solar panel is detachable from the portable medical device.

4. The power supply of claim 1, wherein the interface includes an amplifier.

5. The power supply of claim 1, wherein the interface includes a converter.

6. The power supply of claim 1, wherein the interface includes a connector.

7. The power supply of claim 6, wherein the connector is selected from a group consisting of a USB connector, DC connector, and AC connector.

8. The power supply of claim 1, wherein the portable medical device comprises a medical imaging device.

9. A portable medical system, comprising:
a medical device having an imager and a power storage device;
a detachable solar charging system capable of recharging the power storage device; and
an interface connecting the imager with the solar charging system, configured for regularizing the output of the solar charging system to make it usable for recharging the power storage device.

10. The portable medical system of claim 9, wherein the medical device is selected from a group consisting of an ultrasound imaging system, a patient monitoring system, a portable drug delivery system, and a portable life support system

11. The portable medical system of claim 9, wherein the medical device can be hand-carried.

12. The portable medical system of claim 9, wherein the solar charging system includes at least one foldable solar panel.

13. The portable medical system of claim 9, wherein the interface includes an amplifier.

14. The portable medical system of claim 9, wherein the interface includes a converter.

15. The portable medical system of claim 9, wherein the interface includes a connector.

16. A method of providing uninterrupted power to a portable medical device, comprising:
providing a power storage device integrated with a portable medical device; and
recharging the power storage device using a detachable solar charging system.

17. The method of claim 16, wherein providing the power storage device comprises providing rechargeable batteries in the portable medical device.

18. The method of claim 16, wherein recharging the power storage device comprises providing a foldable solar panel with an interface to recharge the power storage device.

19. The method of claim 16, wherein recharging the power storage device comprises configuring an interface for connecting the solar charging system with the portable medical device.

20. The method of claim 19, wherein recharging the power storage device further comprises configuring the interface for regularizing the output power of the solar charging system to make it usable for recharging the power storage device.
